(19) United States
(12) Patent Application Publication
(10) Pub. No.: US 2012/0134739 A1
(43) Pub. Date: May 31, 2012

(54) TRANSVERSE WEB FOR AN ELEMENT OF A LINE GUIDING DEVICE

(75) Inventors: Gunter Blase, Bergisch Gladbach (DE); Georg Theiss, Koln (DE); Andreas Hermey, Hennef (DE); Frank Blase, Bergisch Gladbach (DE); Harald Nehring, Bonn (DE)

(73) Assignee: IGUS GMBH, Koln (DE)

(21) Appl. No.: 13/264,878

(22) PCT Filed: Apr. 15, 2010
(86) PCT No.: PCT/EP10/54978

§ 371 Date: Jan. 17, 2012

(30) Foreign Application Priority Data
Apr. 17, 2009 (DE) 20 2009 005 737.2

(51) Int. Cl. F16B 1/00

(52) U.S. Cl. 403/6

(57) ABSTRACT

The invention relates to a transverse web for connecting two side parts of an element of a line guiding device, comprising a toggle lever closure (2) having an actuating part (3) and a locking part (4), wherein the actuating part (3) can be swiveled from the locking position completely to the unlocking position in one step by means of a tool (B), and wherein in an engagement area (10) at a distance to the free end (8) of the actuating part (3) and to the swivel axis (axes), a lateral recess (11) for engaging the tool (W) in the transverse web (1) and for applying a force by means of the tool (W) with at least one force component in the direction of the swivel motion of the actuating part (3) to the unlocking position thereof is provided, wherein the recess (11) is laterally delimited by the opening edge (12) of the opening (9) and the actuating part (3).

The invention relates to a transverse web for connecting two side parts of an element of a line guiding device, wherein the transverse web is lockable to the side part to be connected there at least on one end thereof, wherein the transverse web comprises a toggle lever closure having an actuating part and a locking part, the locking part is connected to the actuating part via a toggle lever, the actuating part is connected to the transverse web by a bearing section provided at its end and is supported for swiveling about a swivel axis, and the locking part can be displaced by means of the actuating part at least substantially in the longitudinal direction of the transverse web toward the end of the transverse web connectible to the side part and to a locking position in which the transverse web is lockable to the side part and in which the actuating part is integrated in the outer contour of the transverse web, and can be displaced away from this end to an unlocking position in which the transverse web can be unlocked from the side part and in which the actuating part, for its operation from outside, penetrates the outer contour of the transverse web through an opening provided on the outside of the transverse web, with a free end spaced from the bearing section, a recess for engaging the tool in the transverse web and for a applying a force by means of the tool with a least one force component in the direction of the swivel motion of the actuating part to the unlocking position thereof being provided, wherein the recess is laterally delimited by the opening edge of the opening and the actuating part.

A transverse web of like kind is described in WO 2008/125084 A1 or DE 20 2007 005 566 U. Here the actuating part for opening the toggle lever closure is operated in two steps, wherein an initial opening is caused in first step using a tool, with the free end of the actuating end protruding over the outer contour thus far that it can be usually manually gripped in a second step and can be further introduced into the unlocking position. This two-step opening operation using a tool and involving a continued operation by hand is relatively complicated and time-consuming.

In WO 2007/076987 A1, a transverse web having a transverse pin at its end is described as a swivel axis for the connection of two side parts of a line guide conduit, wherein the transverse pin interlocks with an elastic locking member in a top side seat of the associated side part. The locking can be released by means of a tool. In US 2007/0071544 A1, a line guide conduit comprising transverse webs and lateral lugs is disclosed, wherein the transverse web includes claw-shaped locking element on both ends thereof, each of which can be displaced in a locking manner via a provided on the top side of the side parts. For releasing the connection, a tool engages in top side openings on the transverse web.

The invention is thus based on the object of providing a transverse web of the above-described kind, of which the toggle lever closure is easier to handle.

According to the invention, this object is achieved by the features of claim 1. Advantageous further developments are described in the attached subclaims. The object is achieved particularly in that the actuating part can be swiveled from the locking position completely to its unlocking position in one step by means of a tool, and that the recess is laterally arranged in an engagement area at a distance to the free end of the actuating part and to the swivel axis, which engagement area is arranged on the actuating part between a connection area of the actuating part in which the actuating part is pivotably connected to the toggle lever, and the swivel axis of the actuating part.

As a result of the arrangement of the recess laterally in an engagement area at a distance to the free end of the actuating part and the swivel axis, a force lever is formed corresponding to the distance to the swivel axis which is reduced compared to prior art. As a result of this reduced force lever, the actuating part can be swiveled from its locking position to the unlocking position in one working step by means of the tool. Accordingly, no additional, second step is required for swiveling the actuating part to its unlocking position, such as grabbing and engaging the tool in the recess again.

Preferably, the actuating part can be operated by means of a lever action of the tool thus facilitating the manual application of force by means of the tool. The edge of the opening in the engagement area of the lateral recess can be formed as a lever support or fulcrum for the tool. Thus the tool can be engaged at the actuating part via a tool load arm which in the engaged position of the tool extends from the opening edge of the recess towards an engagement point. In a corresponding manner, a moment of force can be exerted on the load arm via a tool lever arm which in the engaged position of the tool extends from the opening edge to an engagement point of the force application to the tool. In the case of a slotted screw driver comprising a grab handle, a shaft and a flat tool end, the load arm can merely comprise the short end of the tool, whereas the lever arm can be formed by the shaft and, corresponding to the engaging hand of a user, by a part of the grab handle. Thus the tool lever arm can comprise a multiple of the tool load arm. By means of the relatively large tool lever arm, the actually short lever arm of the actuating part which extends from the engagement point of the tool at the actuating part to the swivel axis of the actuating part, can be compensated with regard to the force to be applied by the user easily and in such a manner that swiveling from the locking position to the unlocking position is possible without high efforts on part of the user.

For the purpose of facilitation, especially for the inexperienced user, the edge of the opening or the recess can be optically clearly emphasized regarding the opening process, either in a visually striking and/or self-explaining manner, by optical marks such as printed and/or cast arrows and/or pictograms. For additionally facilitating the actuation of the toggle lever closure, said recess for the engagement of the tool can be respectively provided on both sides of the actuating part. The engagement openings are preferably at the same level with regard to the longitudinal extension of the actuating part, i.e. the engagement openings face each other with regard to the longitudinal axis.

Preferably, the recess in the locking position of the actuating part is slit-shaped. To this end, the recess can longitudinally extend in the longitudinal direction of the transverse web.

Constructionally, the recess can be formed by the opening and/or the actuating part having an incision in the engagement area. The recess can be formed by the actuating part being mutually spaced laterally with respect to the opening edge in the engagement area.

It is considered as an advantage if the recess is designed in an inwardly expanding manner. This provides for a corresponding inwardly expanded free space for the tool movement. The recess can expand in a wedge or cone-like fashion. The tool can thus be inserted in the transverse web more easily and swiveled against the actuating part in the free space, with the edge of the opening forming the fulcrum. By its engagement at the edge of the opening which serves as a lever support or fulcrum, the end of the tool which is inserted towards the transverse web can be more easily positioned for engaging the actuating part.

The actuating part, while delimiting the recess, can include a guide surface for the tool. The tool can slide with its working end engaging in the recess against this guide surface as far as to a lower edge or lower side of the actuating part. The guide surface can be adapted in a manner corresponding to the tool to be preferably used. The guide surface can be laterally delimited while forming a groove so that the tool, in order to be guided, can strike laterally. Preferably, a plane guide surface can be provided which together with the swivel axis can include an angle smaller than 90°, preferably smaller than 70°.

In order to form a swivel joint for the actuating part, the bearing section can include a transverse bead forming the swivel axis. The transverse bead can extend over the entire width of the actuating part. Moreover, the transverse bead can be designed in such a manner that it is bent at right angles away from the outwardly facing top side of the actuating part. This enables the actuating part to be completely sunk in the transverse web in the locking position of the actuating part.

In a further development of the transverse web, the bearing section can include two protrusions which substantially extend in the longitudinal direction of the transverse web and are designed as engagement arms. These engagement arms can each have an end thickening forming a section of the transverse bead. For forming the swivel joint, the bearing can include a transversely extending bearing groove which is adapted to the transverse bead and in which the transverse bead can be fixed to the transverse web for pivoting into a locking seat, preferably under the formation of a snap fit. Concerning the direction of the swivel axis, the engagement arms can be spaced from each other and can each be mounted preferably laterally on the outside. Moreover, the engagement arms can be resiliently deflected in the direction of the swivel axis in such a manner that in the engagement position in the bearing, the engagement arms engage in the bearing while being at least slightly elastically biased, with the spring forces thereof being directed oppositely to each other. Thanks to the elastic engagement arms, the insertion of the toggle lever closure in the transverse web or the insertion of the actuating part in the swivel joint are facilitated by the actuating element which can be pressed into the transverse web under resilient deflection of the engagement arms in the bearing. Moreover, due to the elastic biasing, the toggle lever closing can be more strongly anchored in the transverse web.

The engagement arms can be lockable in the bearing. To this end, the engagement arms can be designed in a hook-like manner, and the thickening at the end thereof can each preferably protrude laterally in the direction of the swivel axis. Preferably, the thickenings are each formed in such a manner that they taper on the outside thereof in the direction away from the free end and in the longitudinal direction of the actuating part in a conical or wedge-like fashion. Thus an inclined plane can be formed on the outer surface on the protrusions through which the engagement arms can be resiliently deflected into the bearing more easily while being engaged by the protrusions.

The bearing section can extend over the entire width of the stop element. For forming the engagement arms, two slits extending in the longitudinal direction can be provided at the ends thereof. Thus a stop element extending in the direction of the engagement arms for limiting the resilient deflection of the engagement arms can be formed centrally with respect to the width of the bearing section. The stop element can be disposed between the engagement arms and respectively spaced from the engagement arms by said slit. The stop element can have the same cross-sectional extension as the engagement arms including the thickening, here for forming a central portion of the transverse bead. Furthermore, the stop element can limit the resilient deflection of the engagement arms towards the center of the bearing section. The central portion of the transverse bead contributes to the stabilization of the swivel joint. The slits can expand towards the bead and, concerning the swivel axis, preferably solely towards the center. Thus an optimum can be achieved between a free space for swiveling the associated engagement arm provided by the slit, and a mechanical stability of the stop element.

Besides, especially with regard to the design of the toggle lever as a lever part and with regard to the locking part, the toggle lever closure can be designed in the manner as explicitly described in DE 20 2007 005 566 U1. Similarly, the actuating part with the exception of the above described features can be designed in the same or in a similar manner as the actuating part of the locking closure in DE 20 2007 005 566 U1. For this reason the disclosure content of DE 20 2007 005 566 U1 is herewith included by reference.

The toggle lever can include a lever part, which is connected to the actuating part by a first end via a first hinge and to the locking part by a second end disposed oppositely to the first end and via a second hinge. The hinges are preferably film hinges. The actuating part, the lever part and the locking part can thus be integrally formed as a plastic part, e.g. by injection molding.

In a useful further development, the actuating part, the lever part and the locking part include limit stops limiting the swiveling of the lever part relative to the actuating part and the locking part to the respective substantially stretched position.

In a preferred further embodiment, the actuating part includes on its end opposite the swivel bearing in or at the transverse web a lug part which extends over the lever part. The lug part increases the lever length of the actuating part of the toggle lever so that the locking can be effected with only a relatively small manual force being required.

The lug part preferably protrudes in a region of the actuating part having an increased material thickness.

In the locking position, the actuating part and the toggle lever can be connected to each other by means of a snap connection, and the snap connection can be released by pivoting the actuating part from the locking position to the unlocking position. To this end, the actuating part can include a snap tab pointing to the toggle lever preferably on the bottom side of its free end, and in the locking position said snap tab can snap in place in a locking groove provided on the top side of the toggle lever. The snap connection can also be formed by mutually engaging locking hooks on the bottom side of the free end or on the top side of the toggle lever.

One element of a line guiding device that can be composed of several mutually pivotable elements can include two opposite side parts and a transverse web interconnecting the same according to one of the above-described embodiments.

One embodiment of the present invention will now be described in more detail with reference to the attached drawings wherein it shown by:

FIG. 1 a perspective top view of a web including two toggle lever closures in an unlocking position;

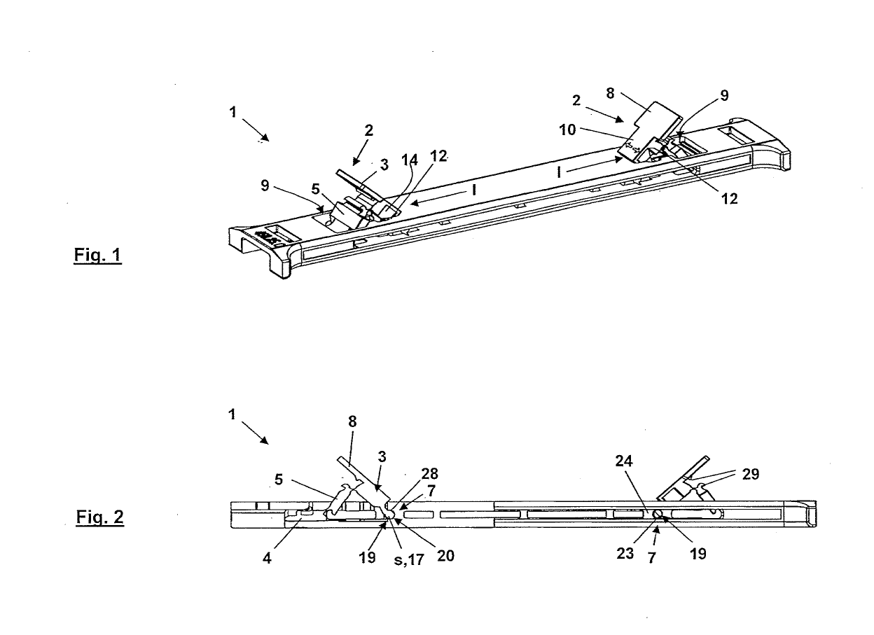

FIG. 2 a lateral view of the transverse web according to FIG. 1, with a left part of the transverse web illustrated in a longitudinal sectional view;

FIG. 3 a perspective top view of an end of the transverse web according to FIG. 1, with the toggle lever closure shown in a locking position, and a view of a tool engaging in the toggle lever closure;

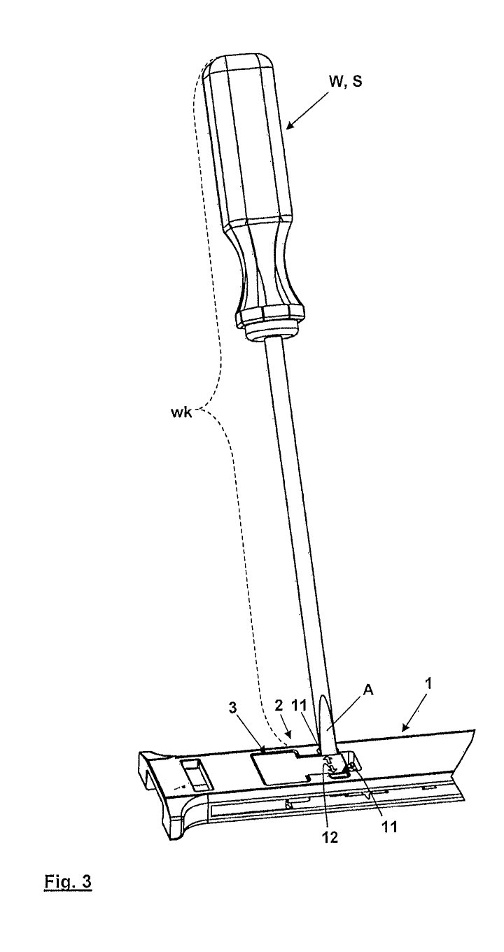

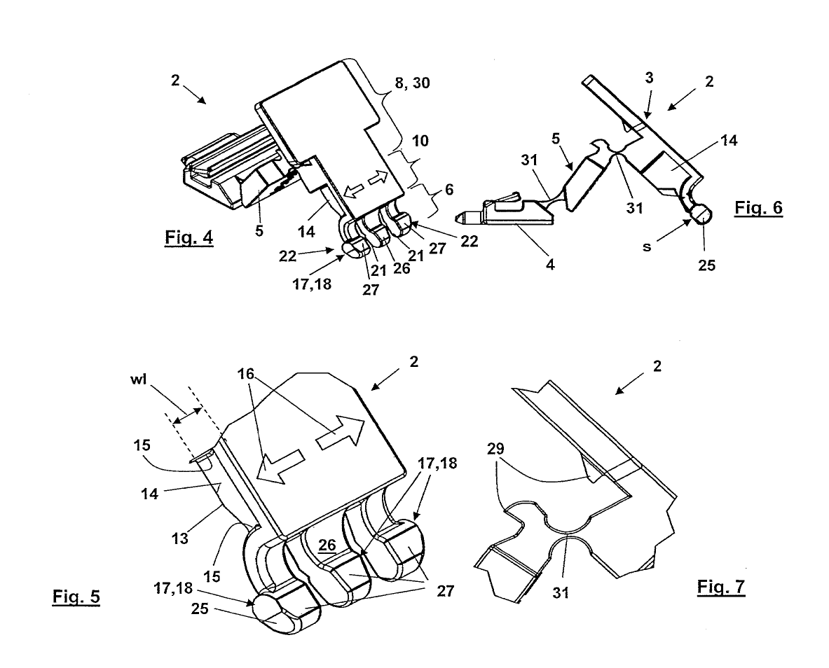

FIG. 4 a perspective top view of the toggle lever closure including an end-side bearing section;

FIG. 5 a detail according to FIG. 4 including the bearing section;

FIG. 6 a lateral view of the toggle lever closure according to FIG. 4; and

FIG. 7 an enlarged detail of the toggle lever closure according to FIG. 6.

The FIGS. 1 to 3 show various views of a transverse web 1 including a toggle lever closure 2 for the connection of two side parts (not further shown in the drawing) of an element (not shown) of a line guiding device (not shown). In the illustrated embodiment, the transverse web 1 can be locked with the two ends thereof to the side parts by means of the toggle lever closure 2. FIG. 3 additionally shows a tool W in the form of a slotted screw driver S, which is applied against the toggle lever closure 2 for actuating the same. The FIGS. 4 to 7 show various views of a toggle lever closure 2 and enlarged details.

The toggle lever closure 2 of the illustrated embodiment of the transverse web 1 is designed as a one-piece injection-molded plastic part. It comprises an actuating part 3 and a locking part 4, and the locking part 4 is connected to the actuating part 3 via a toggle lever 5. The actuating part 3 is supported with an bearing section 6 at the end thereof in a bearing 7 of the transverse web 1 for swiveling about a swivel axis s in or on the transverse web 1. In the illustrated embodiment of the transverse web 1, a toggle lever closure 2 is provided on each of its two ends. For locking the transverse web 1, the respective locking part 4 can be moved by means of the associated actuating part 3 in the longitudinal direction 1 of the transverse web 1 towards the end of the transverse web 1 connectible to the side part into a locking position in which the transverse web 1 can be locked to the side part S. In a corresponding manner, the respective locking part 4 can be moved away from the associated end to an unlocking position in which the transverse web 1 can be unlocked from the side part S. As shown by FIG. 3, the actuating part 3 in its locking position is completely integrated in the outer contour of the transverse web 1. As illustrated by the FIGS. 1 and 2, the actuating part 3 penetrates the outer contour of the transverse web 1 through an opening 9 provided on the outer surface of the transverse web 1, with a free end 8 thereof spaced from the bearing section 6 so that it can be grabbed by hand for its actuation.

According to the invention, the actuating part 3 can be swiveled from the locking position according to FIG. 3 completely to the unlocking position according to the FIGS. 1 and 2 in one step by means of a tool W. To this end, in an engagement area 10 of the actuating part 3 at a distance to the free end 7 of the actuating part 3 and to the swivel axis s, a lateral recess 11 for engaging the tool W in the transverse web 1 is provided. The recess 11 can be arranged in the transverse web 2 and adapted to the tool W, in this case the slotted screw driver S, in such a manner that the slotted screw driver S can be applied with its working end A against the actuating part 3 on the bottom side thereof in the transverse web 1 and can apply a force with at least one force component in the direction of the swivel motion of the actuation part 3 to the unlocking position thereof. The recess 11 is laterally delimited by the opening edge 12 and the actuating part 3. For being adapted to the flat working end A, the recess 11 is slit-shaped, and the recess longitudinally extends in the longitudinal direction 1 of the transverse web.

The actuating part 3 can be moved by means of a lever action of the tool W. The opening edge 12 in the engagement area of the recess 11 serves as a lever support or fulcrum for the slotted screw driver. The slotted screw driver S is inserted with its flat working end A in the recess 11 until it grips under the bottom side of a lower edge 13 of the actuating part 3. Furthermore, it is supported against the opening edge 12. The slotted screw driver S can thus engage the actuating part 3 via a tool load arm Wl which in the inserted position of the slotted screw driver S extends from the opening edge 12 up to the lower edge 14 of actuating part 3. The remaining length of the slotted screw driver S from the opening edge 12 up to its handle end G can serve as a tool force arm Wk. As shown solely by the illustration of FIG. 3, the tool force arm Wk of the slotted screw driver (S) which is used in this case, is many times higher than the tool load arm Wl so that the actuating part 3 can be lifted out of the transverse web 1 by applying only little force. As the recess 11 is arranged with a small distance to the swivel axis s, the actuating part 3 can be moved from the locking position to the unlocking position in one step by means of the slotted screw drivers.

As it can be seen in FIG. 3 and in the FIGS. 1 and 2, the actuating part can be moved from the locking position completely to the unlocking position in one step by means of the slotted screw driver S only if the engagement area 10 on the actuating part 3 is not disposed above the toggle lever 5 and the locking part 4 but between the connection area of the actuating part 3 and the swivel axis s of the actuating part 3. Only then it is possible to swivel the actuating part 3 completely to its unlocking position in one step by means of the lever action of the slotted screw driver S, with the opening edge 12 in the engagement area 10 of the recess 11 serving as a lever support for the slotted screw driver S.

The recess 11 expands inwards in a wedge-like fashion. To this end, the actuating part 3 includes a guide surface 14 on which the tool W with its working end A can slide along towards the lower edge 13. The guide surface 14 together with the swivel axis s forms an angle of less than 90°. This can be clearly seen particularly in the FIGS. 4 and 5. The guide surface 14 is laterally limited by limit stops 15. This prevents the working end A being displaced in the longitudinal direction 1 while it is inserted in the recess 11.

In the illustrated embodiment of the transverse web, two opposing recesses 11 are provided on both sides which can be selectively used for inserting the tool W. On the top side of the actuating part 3 arrows 16 are additionally provided, each of which pointing to an associated recess 11.

At the end of its bearing section 6 the actuating part 3 has a thickening 18 in the form of a transverse bead 17 which for forming a swivel joint 19 engages in the bearing 7. The bearing 7 on its part includes a bearing groove 20 for receiving the transverse bead 17. On the end of the transverse web 1 and extending in the longitudinal direction 1 thereof, two slits 21 are formed in the bearing section 6. As shown by the FIGS. 4 and 5, two lateral engagement arms 22 with the thickening 18 at the ends thereof are formed by said slits 21. The thickening 18 provided at the end in turn forms a part of the transverse bead 17 and thus a part of the swivel axis s, the transverse bead 17 respectively protruding over the outer contour of the actuating part 3 or the bearing section 6. The engagement arms 22 are thus formed in a hook shape. The engagement arms 22 can be resiliently deflected in the direction of the swivel axis s.

As is can be seen particularly in FIG. 7 at the right end of the transverse web 1, the bearing groove 20 respectively terminates laterally in a bearing opening 23 that is formed in a lateral wall 24 of the transverse web 1.

With the mounting of the toggle lever closure 2 in the transverse web 1 the actuating part 3 is placed with its bearing section 6 in the bearing 7. To this end, the engagement arms 22 are swiveled in the transverse direction towards the center of the bearing section, with the thickening 18 at the end of the engagement arms 22 sliding against the lateral walls 24 of the transverse web 1. As soon as the bearing opening 23 is reached, the engagement arms 22 swivel laterally into the bearing opening with the thickening 18 provided at the end thereof so that the actuating part 3 becomes locked in the bearing 7. In this way, the engagement arms 22 can engage in their respective bearing opening 23 while being slightly elastically biased. In this way, the toggle lever closure 2 can easily click into the transverse web with the actuating part 3 thereof. For further facilitating the mounting, the end thickenings 18 of the engagement arms 22 are designed so as to taper in the direction away from the free end in a wedge-like manner while respectively forming an outwardly facing guide surface 25. The guide surface 25 act as inclined planes when the actuating part 3 is mounted with its bearing section 6 into the bearing 7 of the transverse web 1.

Concerning the direction of the swivel axis s, a stop element 26 for limiting the elastic deflection of the engagement arms 22 is provided centrally and between the engagement arms 22. The stop element 26 has the same longitudinal cross section as the engagement arms 22 comprising the end thickening 18 for forming the swivel axis s. FIG. 5 clearly shows that the stop element 26 tapers in the direction away from the free end 8 of the actuating part 3. Thus an optimum is achieved with regard to a sufficient swiveling range of the engagement arms 22 towards the center and with regard to a mechanical stability of the stop element 26.

As further shown by the FIGS. 4 to 6, the thickenings 18 have a flatting 27 on each of its top and bottom sides by which a reduction of the cross section is achieved at this point. Hereby the transverse bead 17 in a particular position can be more easily inserted in the bearing 20 in which the flattening 27 simultaneously serves as sliding surface on the opening edges 28 of the bearing groove 20. The opening edges 28 of the bearing groove 20 are arranged at distance from each other which is smaller than the diameter of the cross section of the bearing groove 20 which is circular in this case.

The FIGS. 6 and 7 illustrate a further advantageous feature of the toggle lever closure 2 in which on the lower side of the actuating part 3 and on the upper side of the toggle lever 5 a respective locking hook 29 is disposed. In the locking position, which is not illustrated here and in which the toggle lever closure 2 is arranged in an elongate manner, said locking hooks 29 engage each other while forming a locking connection. The toggle lever closure 2 is thus held in a flat and elongate manner in its locking position inside the outer contour of the transverse web 1.

As also described in DE 20 2007 005 566 U1 referenced herein, the toggle lever 5 is arranged below a lug section in the locking position thereof. The lug section 30 serves for manually moving the actuating part 3 from the unlocking position to the locking position. The toggle lever 5 is connected to the actuating part 3 or locking part 4 via film hinges 31. The locking part is supported in the transverse web 1 for displacement in the longitudinal direction 1. By actuating the actuating part 3 the locking part 4 can be moved in the transverse web 1 between the locking position and the unlocking position.

### Transverse Web for an Element of a Line Guiding Device

### LIST OF REFERENCE NUMBERS

1 transverse web
2 toggle lever closure
3 actuating part
4 locking part
5 toggle lever
6 bearing section
7 bearing
8 free end
9 opening
10 engagement area
11 recess
12 opening edge
13 lower edge
14 guide surface
15 limit stop
16 arrow
17 transverse bead
18 thickening
19 swivel joint
20 bearing groove
21 slit
22 engagement arms
23 bearing opening
24 lateral wall
25 guide surface
26 stop element
27 flattening
28 opening edge
29 locking hook
30 lug section
31 film hinge
A working end
S slotted screw driver
W tool
l longitudinal direction
s swivel axis
wl tool load arm
wk tool force arm

1-13. (canceled)

14. Transverse web for connecting two side parts of an element of a line guiding device, wherein the transverse web can be locked to the side part there connectible at least at one of its ends, wherein the transverse web comprises a toggle lever closure (2) having an actuating part and a locking part, the locking part is connected to the actuating part via a toggle lever, the actuating part is supported with an end bearing section thereof in a bearing for swiveling about a swivel axis in the transverse web, and the locking part is movable at least substantially in the longitudinal direction of the transverse web towards the end of the transverse web connectible to the side part to a locking position in which the transverse web can be locked to the side part and in which the actuating part is integrated in the outer contour of the transverse web, and is movable away from the said end to an unlocking position in which the transverse web can be released from the side part and in which the actuating part, for being operated from outside, penetrates the outer contour of the transverse web through an opening provided on the outside of the transverse web with a free end spaced from the bearing section, a recess for engaging the tool in the transverse web and for a applying a force by means of the tool with a least one force component in the direction of the swivel motion of the actuating part to the unlocking position thereof being provided, wherein the recess (11) is laterally delimited by the opening edge of the opening and the actuating part, characterized in that the actuating part can be swiveled from the locking position completely to the unlocking position in one step by means of a tool and that the recess is laterally arranged in an engagement area at a distance to the free end of the actuating part and to the swivel axis, which engagement area is arranged on the actuating part between a connection area of the actuating part in which the actuating part is pivotably connected to the toggle lever, and the swivel axis s of the actuating part.

15. Transverse web according to claim 14, characterized in that the actuating part is movable by means of a lever action of the tool, with the opening edge of the opening (9) in the engagement area of the recess serving as a lever support or fulcrum for the tool.

16. Transverse web according to claim 15, characterized in that the recess is slit-shaped and that the recess longitudinally extends in the longitudinal direction of the transverse web.

17. Transverse web according to claim 15, characterized in that the recess is formed so as to expand inwards.

18. Transverse web according to claim 17, characterized in that the actuating part includes a guide surface for the tool delimiting the recess.

19. Transverse web according to one of the claim 14, characterized in that a lateral recess for the engagement of the tool is respectively arranged on both sides of the actuating part.

20. Transverse web according to claim 14, characterized in that for forming a swivel joint for the actuating part, the bearing section comprises a transverse bead forming the swivel axis.

21. Transverse web according to claim 20, characterized in that the bearing section comprises two protrusions substantially extending in the longitudinal direction of the transverse web and designed as engagement arms, each with a thickening at its end that forms a section of the transverse bead.

22. Transverse web according to claim 21, characterized in that the engagement arms are spaced from each other in the direction of the swivel axis and can be resiliently deflected in such a manner that in the position engaged in the bearing, they engage in the bearing while being at least slightly elastically biased in the direction of the swivel axis.

23. Transverse web according to claim 21, characterized in that the engagement arms are lockable in the bearing, with the engagement arms being designed in a hook-like manner.

24. Transverse web according to claim 21, characterized in that the bearing section includes a stop element which extends in the direction of the engagement arms, for limiting the elastic deflection of the engagement arms, and that the stop element is disposed between the engagement arms and respectively spaced from the same via a slit.

25. Transverse web according to claim 24, characterized in that the slit expands towards the transverse bead.

26. Transverse web according to claim 24, characterized in that the stop element has an end thickening for forming a central section of the transverse bead.
